(19) United States
(12) Patent Application Publication
(10) Pub. No.: US 2026/0328676 A1
(43) Pub. Date: Oct. 22, 2026

(54) MICROELECTROMECHANICAL (MEMS) BASED THERMAL INFRARED EMITTER CHIP

(71) Applicant: Taiwan Nano & Micro-Photonics Co., Ltd., Taipei City (TW)

(72) Inventors: Chung-Hua Chao, Taipei City (TW); Hsin-Chuan Wen, Taipei City (TW); Pei-Hung Hsieh, Taipei City (TW); Kun-Yu Chang, Taipei City (TW)

(21) Appl. No.: 19/415,416

(22) Filed: Dec. 10, 2025

Related U.S. Application Data
(60) Provisional application No. 63/791,736, filed on Apr. 21, 2025.

(51) Int. Cl. G01N 21/25; G01N 21/3504

(52) U.S. Cl. CPC G01N 21/255; G01N 21/3504

(57) ABSTRACT

A microelectromechanical (MEMS) based thermal infrared emitter chip comprises a substrate that includes one or more heating regions, with each includes a patterned heating film, a resonant layer, and a metamaterial. The patterned heating film is arranged on the substrate to produce an infrared radiation by converting electrical energy into heat. The resonant layer is disposed on the patterned heating film, and the metamaterial disposed on the resonant layer allows the infrared radiation to pass through within a narrow passband. Irradiation of the metamaterial by the infrared light induces localized surface plasma resonance (LSPR), and the resulting LSPR mode remains strongly confined in the resonant layer. The metamaterial resonantly couples the infrared radiation, resulting in a resonant peak around a central wavelength of the narrow passband.

### CROSS-REFERENCE TO RELATED APPLICATIONS

This application claims the benefit under 35 U.S.C. 119 of U.S. Provisional Patent Application No. 63/791,736 filed on Apr. 21, 2025. This application and all published documents discussed below are fully incorporated by reference as if fully set forth herein.

### BACKGROUND OF THE INVENTION

### 1. Field of the Invention

The present invention relates to MEMS based thermal infrared emitter chip capable of selectively emitting one or more specific wavelengths.

### 2. Description of Related Art

Mid-infrared (Mid-IR) optical sensing technology is a powerful chemical sensing method that has been widely applied in industrial process control and environmental monitoring. It uses light in the 2.5-25 μm wavelength range to detect molecules based on their unique absorption patterns, a phenomenon known as mid-infrared spectroscopy. Common Mid-IR light sources range from simple micro-incandescent lamps to high-performance quantum cascade lasers (QCLs).

Traditional thermal radiation sources operate based on blackbody radiation principles. While they can generate a broad spectral range, their efficiency in narrowband applications is relatively low, making them less suitable for gas detection. In contrast, QCLs provide high spectral density and narrowband emission, making them ideal for highly selective gas sensing. However, the complexity and high cost of their fabrication process limit their practicality in cost-sensitive applications.

U.S. Pat. No. 12,106,957B2 and U.S. Patent Pub. No. US20240420945A1, commonly assigned to the assignee of the present invention, one embodiment of which discloses an infrared thermal emitter with a heating layer sandwiched by top and bottom optical layers that allow only narrow-band infrared light to pass through. A reflective layer may be further provided below the bottom optical layers. This configuration greatly reduces the energy loss and can be manufactured with simple method and low cost.

### SUMMARY OF THE INVENTION

This summary is provided to introduce a selection of concepts in a simplified form that are further described below in the detailed description. This summary, and the foregoing background, is not intended to identify key aspects or essential aspects of the claimed subject matter. Moreover, this summary is not intended for use as an aid in determining the scope of the claimed subject matter.

In some embodiments, this invention provides a thermal infrared emitter chip for non-dispersive infrared detection. For example, the provided chip can be used in the “Self-calibrating Non-dispersive Infrared Detection Apparatus” disclosed in U.S. patent application Ser. No. 19/322,489. The thermal infrared emitter chip is configured to infrared radiation with one or more specific wavelengths corresponding to one or more absorption bands of one or more target components, thereby enabling simultaneous detection of one or more target components in a fluid sample.

Microelectromechanical systems (MEMS)-based thin-film heaters have become an ideal choice for, e.g., miniaturized gas sensors and infrared light emitters due to their advantages of compact size, low power consumption, and fast thermal response. Additionally, Micro Heat Plates (MHPs) have low manufacturing costs and can be easily integrated with Complementary Metal-Oxide-Semiconductor (CMOS) circuits, further enhancing their application potential. By incorporating wavelength-selective optical structures, MHPs can achieve narrowband spectral emission, making them more suitable for precise target component detection.

This invention integrates wavelength-selective optical structures with multiple MEMS-based thin-film heaters, enabling the detection of single or multiple target components. It is compatible with standard CMOS foundry processes, enabling the development of affordable, high-performance gas or liquid sensing prototypes for consumer applications.

This invention integrates various configurations of thin film heaters based on MEMS. A single-chip design features multiple sets of electrode heaters, with a metamaterial optical structure introduced above the heaters to precisely control narrowband emissions at multiple wavelengths. Combined with a circuit control system, this enables selective regional light emission, making it suitable for one or more target components detection. Additionally, a low thermal conductivity material is incorporated beneath each individual heater to effectively isolate heat transfer between adjacent heaters, thereby enhancing the independent control and switching capability of single-wavelength emissions.

The heater design is not restricted to specific geometric shapes or configurations; by optimizing pattern design and material selection, it can be tailored to meet diverse application requirements.

As the manufacturing process of provided thermal infrared emitter chip is compatible with standard CMOS foundry processes, it benefits from mature technology and scalability for mass production. Furthermore, the heater fabrication does not require expensive materials-common metals and ceramics can be used, enabling the development of affordable, high-performance gas or fluid sensing prototypes.

Additional features of the invention are set out in the appended set of claims.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIGS. 1A, 1B, and 1C are cross-sectional, schematic diagram, and perspective views illustrating a microelectromechanical (MEMS)-based thermal infrared emitter chip and physical mechanism thereof according to an embodiment of the present invention. resonant layer.

FIG. 2 shows emission wavelength versus intensity curves of two MEMS thermal infrared emitter chip with and without an optical homogenization layer.

FIG. 3 shows top views of patterned heating films and their temperature distribution after energization according to some embodiments of the present invention.

FIG. 4A shows emission wavelength versus luminous intensity curves of five inventive infrared emitter chips whose resonance layer are made of different materials.

FIG. 4B shows emission wavelength versus luminous intensity curves of four inventive infrared emitter chips whose resonance layer are made of Al₂O₃ with different thicknesses.

FIGS. 5A-5D are schematic top views of some periodic subwavelength structures in accordance with some embodiments of this invention.

FIG. 6A shows emission wavelength versus luminous intensity curves of two inventive infrared emitter chips whose metamaterial are composed of grating nanostructure array with different two-dimensional areas.

FIG. 6B shows emission wavelength versus luminous intensity curves of some inventive infrared emitter chips whose metamaterial are composed of grating nanostructure array with different periods.

FIGS. 7A to 7C are schematic diagram and perspective views showing a MEMS-based thermal infrared emitter chip and physical mechanism thereof according to a preferred embodiment of the present invention.

FIG. 7D shows a bar graph of temperature and thermal radiation of a patterned heating film according to an embodiment of the present invention.

FIG. 8 shows light emission characteristics before and after adjusting area or temperature of individual patterned heating films according to an embodiment of the present invention.

FIGS. 9A to 9D show schematic simplified top views of various arrangement patterns of the patterned heating films in accordance with some embodiments of this invention.

FIG. 10 is a side view showing a microelectromechanical (MEMS)-based thermal infrared emitter chip according to another embodiment of the present invention.

FIGS. 11A and 11B are front and bottom perspective views showing a substrate of a MEMS-based thermal infrared emitter chip according to an embodiment of the present invention.

FIG. 12A is a thermal analysis simulation of two inventive chips wherein one of multiple heating regions is active and the bottom of substrate has or has no etched MEMS structure.

FIG. 12B is a thermal analysis simulation of three inventive chips wherein one of multiple heating regions is active and the bottom of substrate has different etched MEMS structures.

FIG. 13A is a line graph of radiation energy versus area of the patterned heating film according to an embodiment of the present invention.

FIG. 13B is a line graph of radiation energy versus temperature of the patterned heating film according to an embodiment of the present invention.

FIGS. 14A, 14B, and 14C are top views showing metamaterials composed of grating arrays according to some embodiments of the present invention.

### DETAILED DESCRIPTION OF THE PREFERRED EMBODIMENT

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

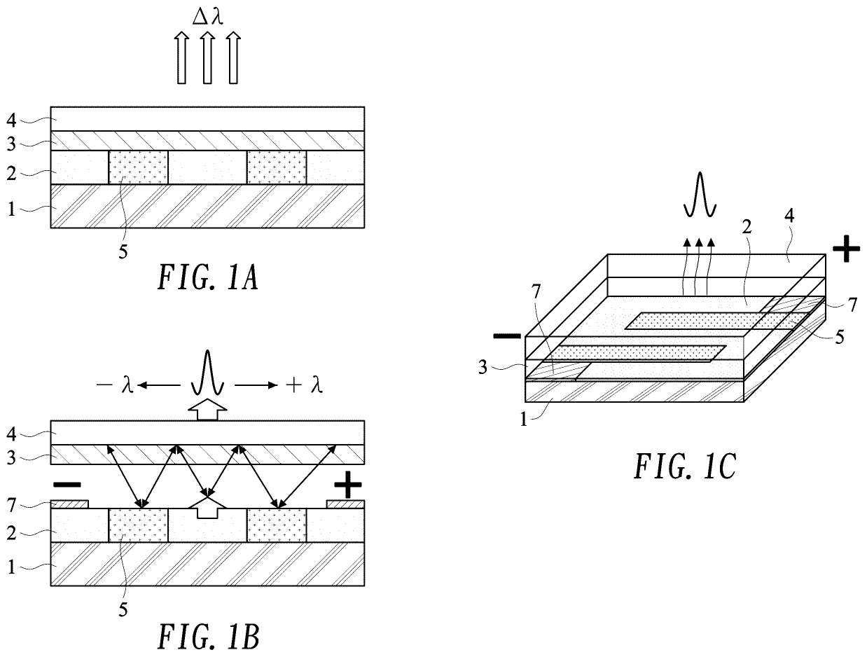

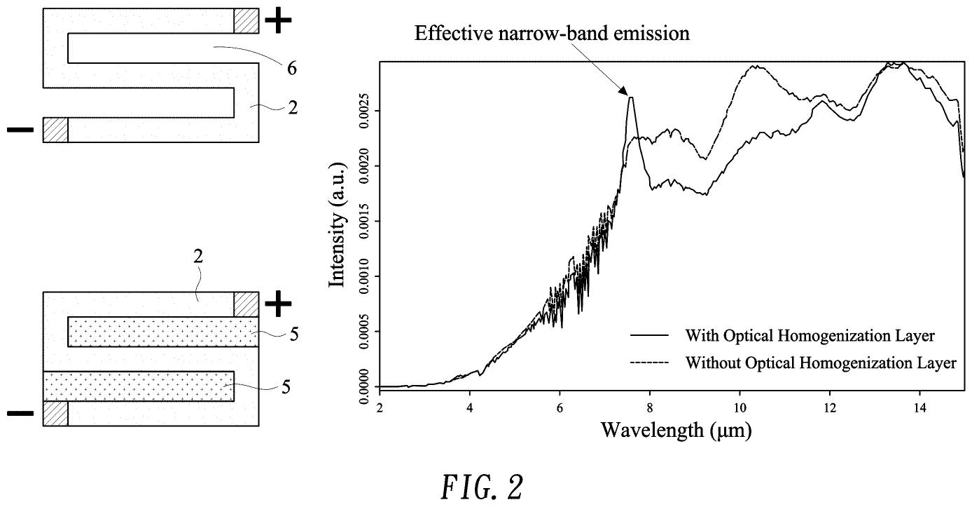

FIGS. 1A, 1B, and 1C are cross-sectional, schematic diagram, and perspective views illustrating a microelectromechanical (MEMS)-based thermal infrared emitter chip and its physical mechanism according to an embodiment of the present invention. The thermal infrared emitter chip includes a substrate 1, a patterned heating film 2, a resonant layer 3, and a metamaterial 4. The patterned heating film 2 is disposed on the substrate 1 and generates an infrared radiation by converting electrical energy into heat. The resonant layer 3 is disposed on the patterned heating film 2. The metamaterial 4 disposed on the resonant layer 3 allows the infrared radiation to pass through within a narrow passband. The metamaterial 4 is composed of periodic sub-wavelength structures made of metal. The metamaterial, the resonant layer 3 made of insulating material, and the patterned heating film 2 made of conductive material constitute a metal-insulator-metal (MIM) structure. Electrodes 7 can be deposited above both ends of the patterned heating film 2 to receive current. The infrared radiation irradiating the metamaterial 4 will generate localized surface plasmon resonance (LSPR), and the resulting LSPR mode remains strongly confined in the resonant layer 3, thereby forming an optical resonant cavity between the upper metamaterial 4 and the lower patterned heating film 2. This resonance excites gap surface plasmons, which are then converted into light radiation. The resonance wave is confined in the resonant cavity formed by the resonant layer 3, and the periodic sub-wavelength structures resonantly couple the infrared radiation to generate a resonant peak at a central wavelength of the narrow passband. The narrowband emission efficiency of the thermal infrared emitter chip is physically based on the high-quality optical resonant cavity formed by its MIM (metal-insulator-metal) structure. The performance of this resonant cavity highly depends on the metal layer (including the patterned heating film 2) at the bottom as a perfect mirror to effectively limit the light energy and establish a standing wave resonance. In an embodiment, the patterned heating film 2 also functions as a Joule heat source, and its necessary electrical patterning creates optical “gaps 6” (see FIG. 2) among the patterns. These gaps 6 cause significant leakage of photons that should be confined within the cavity, thereby disrupting the resonance conditions and preventing effective narrow-band emission.

To solve this critical physical contradiction, in a preferred embodiment, the thermal infrared emitter chip further includes an innovative optical homogenization layer 5 to fill these gaps. The optical homogenization layer 5 is composed of one or more discontinuous patterns, which are located on the substrate 1 without electrically connected to the power source, and do not contact with the patterned heating film 2. Its core contribution is to optically stitch the electrically patterned heating film 2 into a complete, nearly seamless, and perfect mirror, thereby achieving zero leakage and ensuring the complete upward concentration of energy. FIG. 2 shows emission wavelength versus intensity curves of two MEMS thermal infrared emitter chips with and without the optical homogenization layer 5. As shown in FIG. 2, compared with chips without the optical homogenization layer 5, the infrared light emitter chip with the optical homogenization layer 5 can achieve zero leakage and ensure that the light energy is completely concentrated upward in narrowband emission.

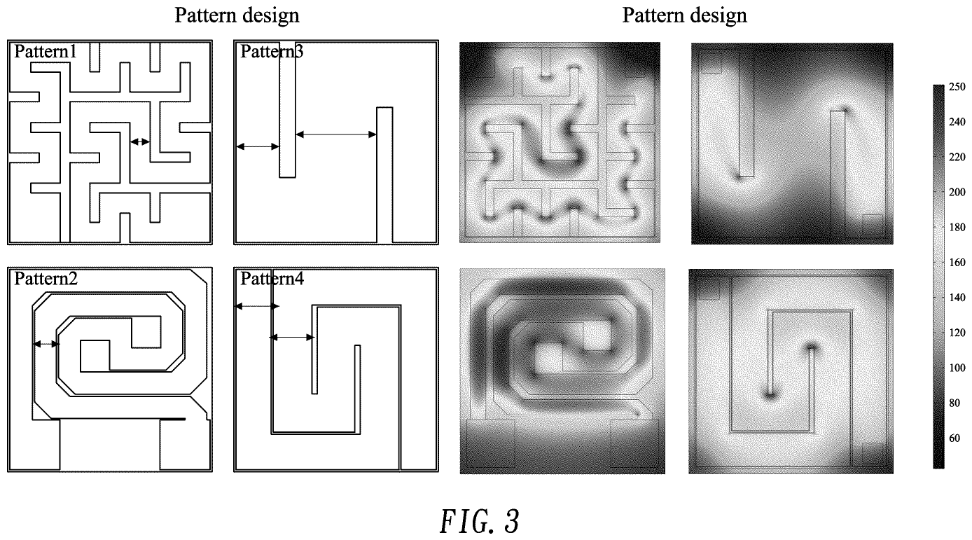

FIG. 3 shows top views of patterned heating films and their temperature distribution after energization according to some embodiments of the present invention. The patterned heating film 2 is a conductive thin film that generates heat through Joule heating. The patterned heating film 2 is made of a conductive material, e.g., titanium nitride (TiN), ceramics, aurum (Au), aluminum (Al), a doped polysilicon, chromium (Cr), or other conductive materials. Two contacts or electrodes 7 may be deposited on ends of the patterned heating film 2 to connect a negative electrode and a positive electrode of a voltage or current source, respectively. To achieve uniform high temperatures, various geometry designs such as spiral, parallel, and serpentine patterns can be employed. In addition, uniform temperature distribution can be further optimized by carefully adjusting parameters such as the spacing, width, and length of the patterned heating film 2.

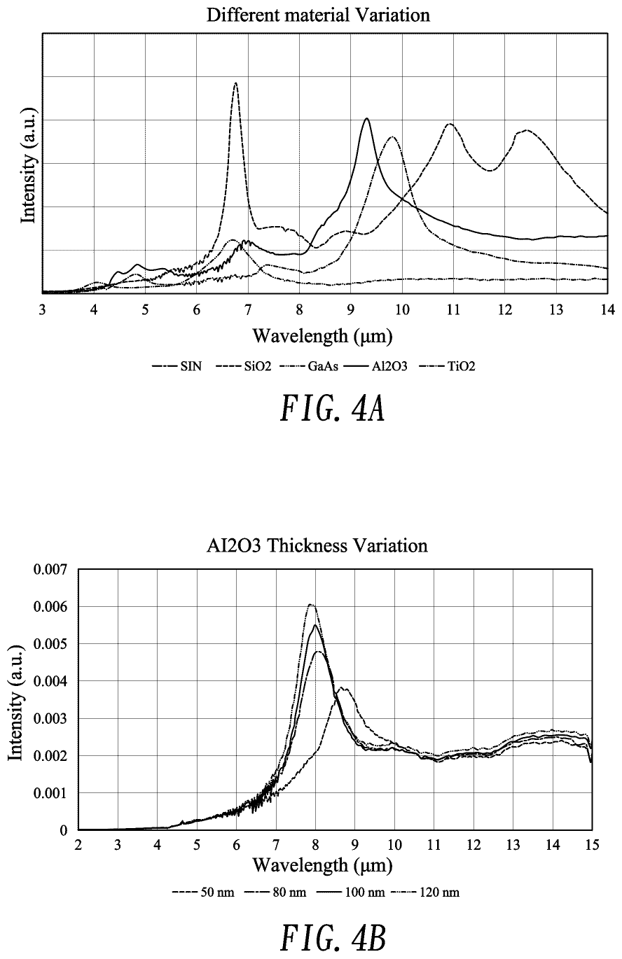

The material of the resonant layer 3 can be nitride or oxide, such as SiO₂, Al₂O₃, SiN, TiO₂, etc. By changing the material or controlling the thickness of the resonant layer 3, the emission wavelength of the infrared light emitter chip can be enhanced or altered. FIG. 4A shows emission wavelength versus luminous intensity curves of five inventive infrared emitter chips whose resonance layer 3 are made of different materials including SiN, SiO₂, GaAs, Al₂O₃, and TiO₂. FIG. 4B shows emission wavelength versus luminous intensity curves of four inventive infrared emitter chips whose resonance layer are made of Al₂O₃ with different thicknesses including 50 nm, 80 nm, 100 nm, and 120 nm.

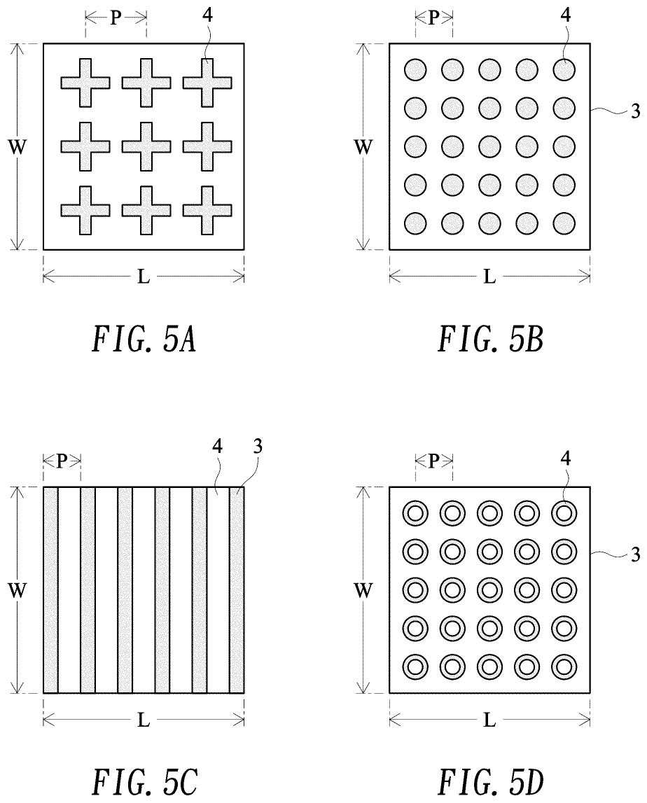

FIGS. 5A to 5D are schematic top views of some periodic subwavelength structures in accordance with some embodiments of this invention. Referring to FIGS. 5A to 5D, the periodic sub-wavelength structures may be, but is not limited to, a cross (A), circular (B), gratings (C), or semi-circular (D) patterned metal nanostructure array. The metamaterial 4 achieves selective wavelength transmission by tailoring its subwavelength geometric structures to create optical resonances that interact with specific wavelengths of the infrared radiation. By adjusting the size, shape, and arrangement of the periodic subwavelength structures, the metamaterial's desired transmission peaks within a narrow spectral range can be controlled. The resonances vibrate strongly at certain wavelengths, allowing the infrared radiation at those specific frequencies to pass through while reflecting or absorbing other wavelengths. The periodic subwavelength micro/nanostructures could be made of Ag, Au, Al, Cu, or other plasmonic materials to induce localized surface plasmon resonance (LSPR) by interacting with the infrared radiation, and a resonant peak wavelength of the surface plasmon resonance is determined by one or more geometric parameters, e.g., period (P), diameter (d), and/or thickness of the periodic subwavelength structures.

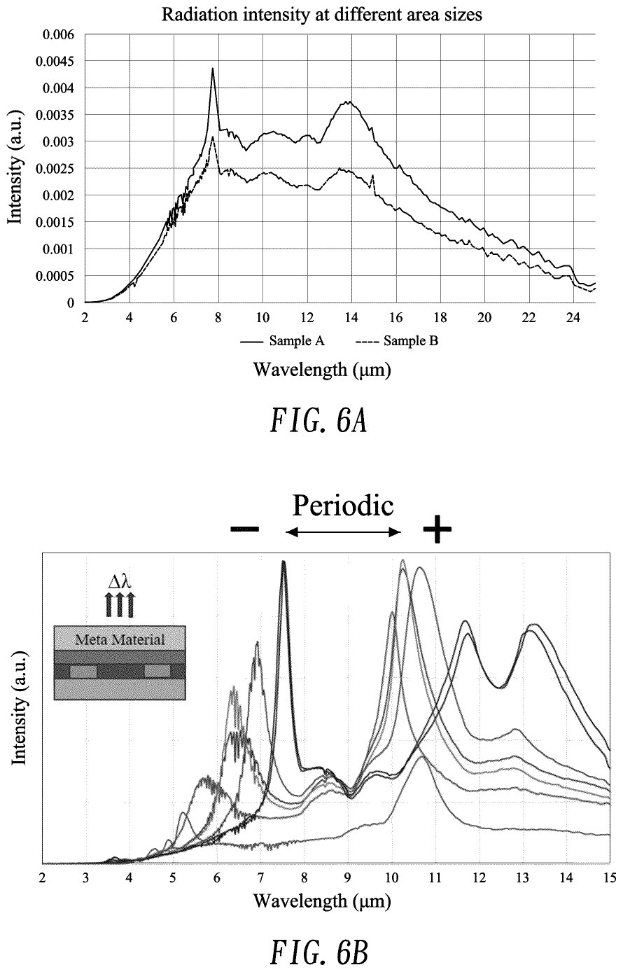

In addition, the light emission efficiency of the chip can be improved by adjusting a two-dimensional area (L×W) of the metal-insulator-metal (MIM) structure. FIG. 6A shows emission wavelength versus luminous intensity curves of two inventive infrared emitter chips (samples A and B) whose metamaterial are composed of grating nanostructure array with different two-dimensional areas. The length (L) of sample A is 3.7 mm, and the length (L) of sample B is 1.5 mm, and the width (W) of both samples is 3.3 mm. The experimental results show that sample A has higher light emission efficiency.

FIG. 6B shows emission wavelength versus luminous intensity curves of some inventive infrared emitter chips whose metamaterial are composed of grating nanostructure array with different periods.

FIG. 6A is a diagram of the emission wavelength and luminous intensity of a thermal infrared emitter chip (samples A and B) with two grating nanostructure arrays. The length (L) of sample A is 3.7 mm, and the length (L) of sample B is 1.5 mm, and the width (W) of both samples is 3.3 mm. The experimental results show that sample A has higher light emission efficiency. FIG. 6B is a diagram of the emission wavelength and luminous intensity of a thermal infrared light emitter chip with a grating nanostructure array of metamaterial 4 at different grating periods (P). The required peak wavelength can be adjusted by changing the period.

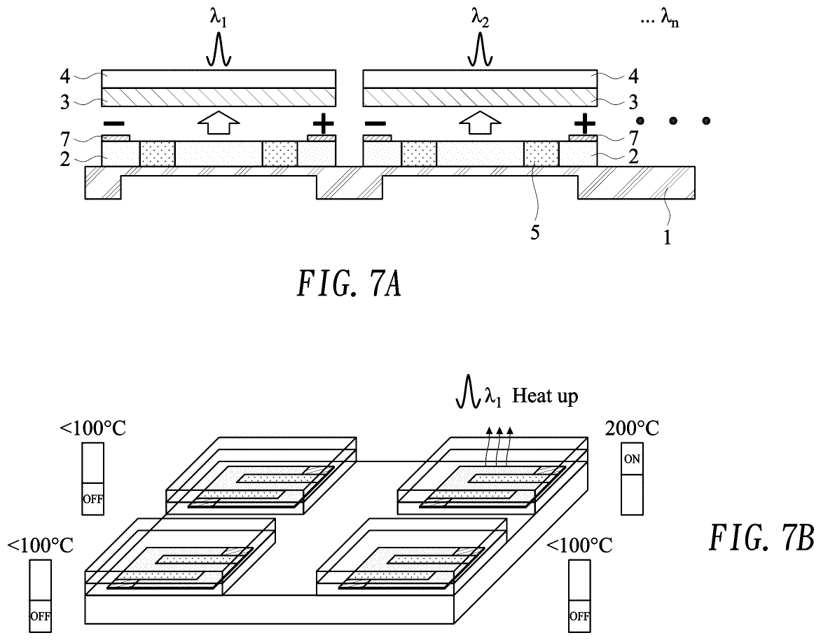

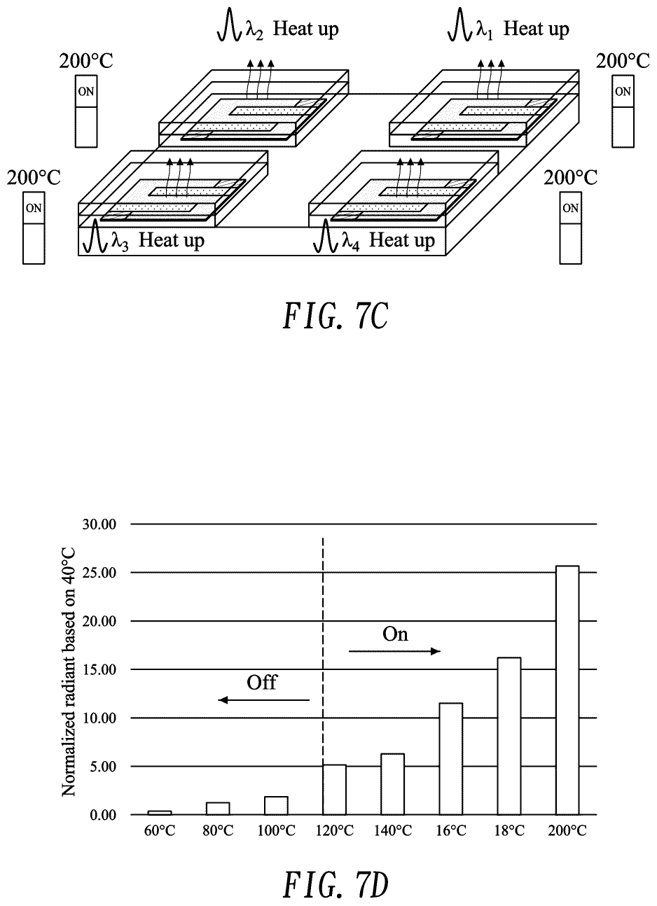

FIGS. 7A-7C are schematic diagram and perspective view showing a microelectromechanical (MEMS)-based thermal infrared emitter chip and its physical mechanism according to a preferred embodiment of the present invention. Referring to FIGS. 7A-7C, the thermal infrared emitter chip is fabricated on a substrate 1 having a plurality of heating regions for generating multiple specific wavelengths. Each heating region includes a patterned heating film 2, a resonant layer 3, and a metamaterial 4 as described in FIGS. 1A to 1C. The patterned heating film 2 is disposed on the substrate 1 to produce an infrared radiation by converting electrical energy into heat. The resonant layer 3 is disposed on the patterned heating film 2. The metamaterial 4 disposed on the resonant layer 3 allows the infrared radiation to pass through within a narrow passband. The metamaterial 4 is composed of periodic subwavelength structures made of metal. The metamaterial, the resonant layer 3 made of insulating material, and the patterned heating film 2 made of conductive material constitute a metal-insulator-metal (MIM) structure. Electrodes 7 can be deposited above both ends of the patterned heating film 2 to receive current. The infrared radiation irradiating the metamaterial 4 will generate localized surface plasmon resonance (LSPR), and the resulting LSPR mode remains strongly confined in the resonant layer 3, thereby forming an optical resonant cavity between the upper metamaterial 4 and the lower patterned heating film 2. This resonance excites gap surface plasmons, which are then converted into light radiation. The resonance wave is confined in the resonant cavity formed by the resonant layer 3, and the periodic sub-wavelength structures resonantly couple the infrared radiation to generate a resonant peak at a central wavelength of the narrow passband.

In some embodiments, multi-wavelength emission on a single chip is realized through precise control of individual heating regions. The patterned heating film 2 of each heating region is independently regulated by a dedicated circuit to eliminate mutual interference between the patterned heating film 2. The emission wavelengths are further refined using the individual metamaterials 4, enabling each heating region to emit at a specific, well-defined wavelength. The desired transmission peaks can be controlled by adjusting the size, shape, and arrangement of the periodic subwavelength structures of individual metamaterials 4, and/or adjusting the area and temperature of the patterned heating film 2 of each heating region.

Referring to FIGS. 7A-7C, in one embodiment the central wavelengths emitted from the plurality of heating regions are different from one another. In the illustrated embodiment, the substrate 1 has four heating regions, and the central wavelengths emitted from the four heating regions, i.e., 21, 22, 23, and 24, are different from one another. In another embodiment, the multiple central wavelengths emitted from multiple heating regions are the same, for example, the central wavelengths emitted from the four heating regions are all 21.

Referring to FIGS. 7A-7C, the patterned heating films 2 of the heating regions are independently and selectively energized or de-energized to enable selective wavelength emission. By selectively heating a specific patterned heating film 2, a specific heating region can emit light at a designated wavelength. Alternatively, when all patterned heating films 2 are heated simultaneously, multi-wavelength light emission occurs. For example, FIG. 7B shows that only the patterned heating film 2 of the first heating region is activated to selectively transmit a specific wavelength 21. And FIG. 7C shows that the patterned heating film 2 of the four heating regions are activated to simultaneously transmit four different specific wavelengths, 21, 22, 23, and 24.

In some embodiments, one or more heating regions are selectively heated to selectively emit one or more specific wavelengths, e.g., 21, and the temperature of the other inactive regions is controlled to be less than a predetermined temperature to prevent interfering with light emission characteristics of the one or more active heating regions.

FIG. 7D shows a bar graph of temperature and thermal radiation of a patterned heating film according to an embodiment of the present invention. As shown in FIG. 7D, the thermal radiation emitted by the patterned heating film 2 increases exponentially with its temperature. A key turning point is observed at 100 °C, above which the enhancement accelerates dramatically as the system's radiant efficiency becomes activated. In one embodiment, the predetermined temperature is 100 °C. In another embodiment, the predetermined temperature is 80 °C. In another embodiment, the predetermined temperature is 60 °C. In another embodiment, the predetermined temperature is 40 °C. The selectively heated heating region can be referred to as the “ON region”, and the other unheated heating regions can be referred to as the “OFF region”. The heat generated by the “ON region” will be conducted to the “OFF region”, and to reduce heat conduction the present invention includes a mechanism that will be described later in detail.

According to Planck's law, the total radiation amount emitted by a blackbody is proportional to the fourth power of its thermodynamic temperature. The peak of the spectrum shifts toward shorter wavelengths as the temperature increases, which is described by Wien's Displacement Law. Therefore, if multiple patterned heating films 2 are designed to emit multiple lights of different specific wavelengths, then when multiple patterned heating films 2 are heated to the same temperature, the lights with different wavelengths will have different intensities. In addition, the signal-to-noise ratio (SNR) is a key indicator to measure data quality, which is defined as the ratio of “signal energy” to “noise energy”. The stronger the light intensity, the higher the signal energy, and the higher the sensing resolution. Therefore, increasing the intensities of lights of different wavelengths to the same level can improve detector capabilities and reduce the need for calibration.

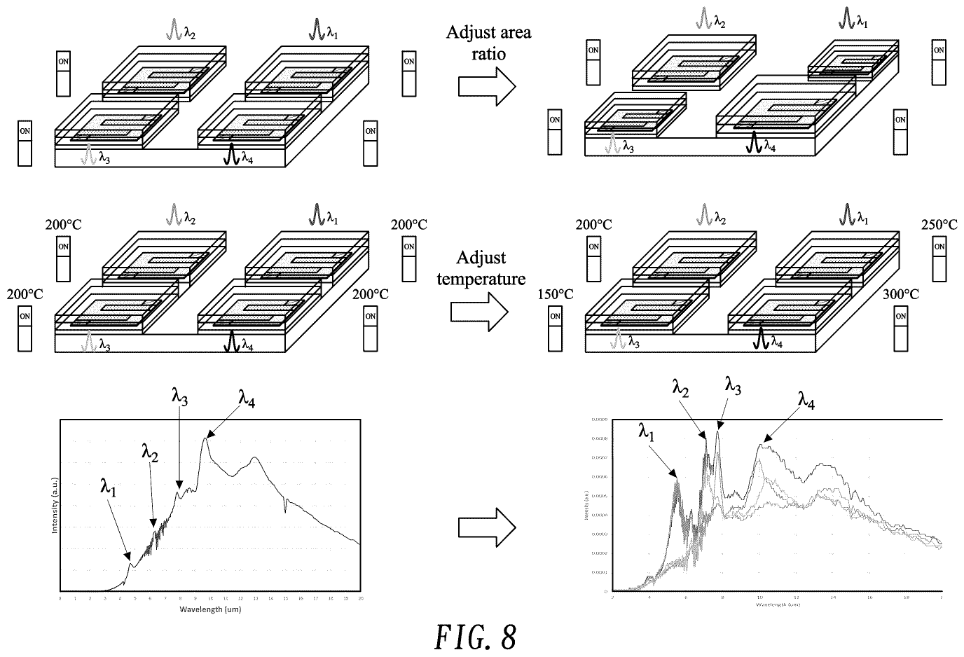

The intensity of light emitted by the patterned heating film 2 is proportional to its area and temperature. In one embodiment, by utilizing independent voltage control to adjust the temperature to area ratio of individual patterned heating film 2, it is possible to achieve emission of lights with different wavelengths on a single chip while making the emitted lights of different specific wavelengths have the same intensity. FIG. 8 shows emission light characteristics before and after adjusting area or temperature of individual patterned heating films 2 according to an embodiment of the present invention. As shown in FIG. 8, by adjusting the area of individual patterned heating films 2 or by independently controlling the voltage to adjust the temperature of individual patterned heating films 2, the intensities of lights with different wavelengths 21, 22, 23, and 24 are made to approach the same. In one embodiment, the area and temperature of individual patterned heating films 2 are both tailored.

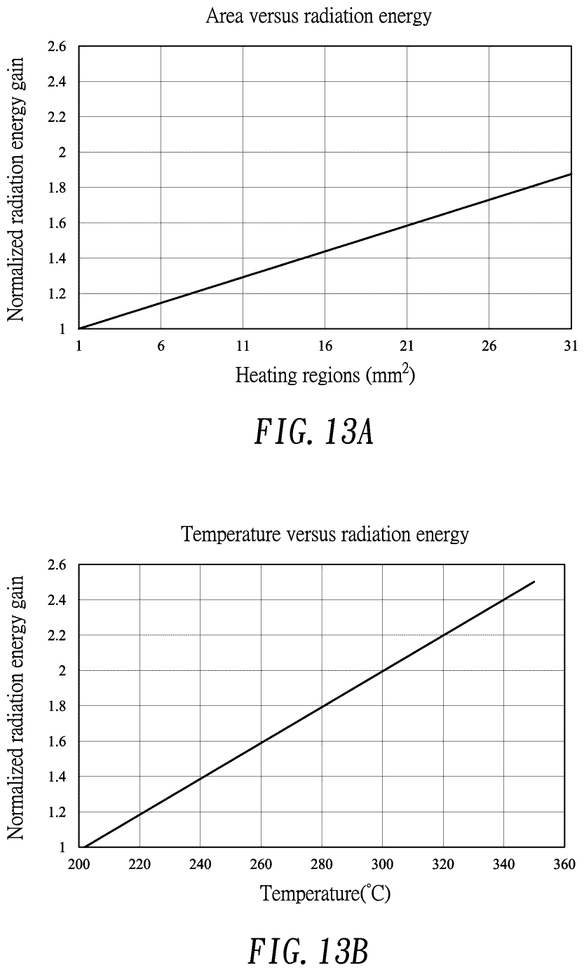

FIG. 13A is a line graph of radiation energy of emission center wavelength versus area of the patterned heating film according to an embodiment of the present invention. Referring to FIG. 13A, the intensity at the center wavelength emitted by each heating region is positively linearly correlated to the area of its patterned heating film, and this positive linear relationship has a first slope.

FIG. 13B is a line graph of radiation energy of emission center wavelength versus temperature of the patterned heating film according to an embodiment of the present invention. Referring to FIG. 13B, the intensity at the center wavelength emitted by each heating region is positively linearly correlated to the temperature of its patterned heating film, and this linear relationship has a second slope. Referring to FIGS. 13A and 13B, the second slope is greater than the first slope.

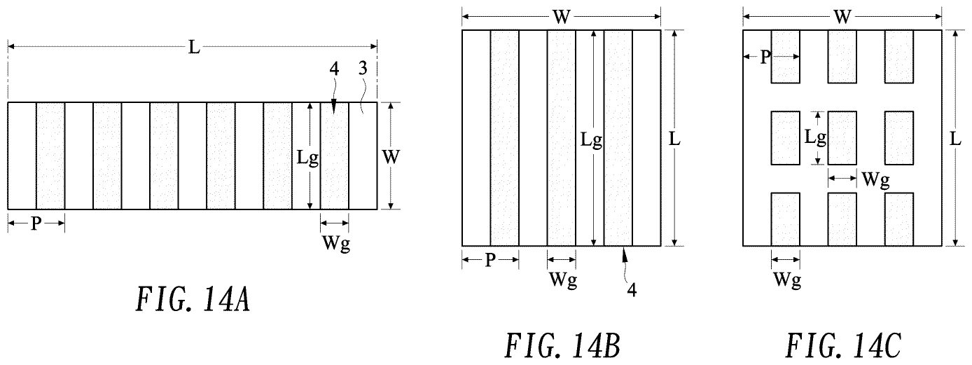

FIGS. 14A, 14B, and 14C are top views showing metamaterials composed of grating arrays according to some embodiments of the present invention. Referring to FIGS. 14A-14C, due to limitations in the size and/or shape of heating region, one or more metamaterials configured as shown in FIGS. 14A-14C may be present simultaneously in the same thermal infrared emitter chip. Referring to FIG. 14A, the metamaterial 4 includes a grating array composed of multiple grating patterns, and the metamaterial 4 includes a length direction (L) and a width direction (W) (corresponding to the length L and width W of the MIM structure), with a length (Lg) of each grating pattern parallel to the width direction (W). Referring to FIG. 14B, the difference from FIG. 14A is that the length (Lg) of each grating pattern is parallel to the length direction (L), that is, the width (Wg) of each grating pattern is parallel to the width direction (W). Compared to FIG. 14B, the structure shown in FIG. 14A has stronger resonant energy and higher radiation energy. Referring to FIG. 14C, the similarity with FIG. 14B is that the length (Lg) of each grating pattern is parallel to the length direction (L); the difference from FIG. 14B is that the grating array is a two-dimensional array, that is, it has multiple grating patterns in both the length direction (L) and the width direction (W). If the number of grating patterns is the same, the structures of FIG. 14A and FIG. 14C have approximately the same radiation energy.

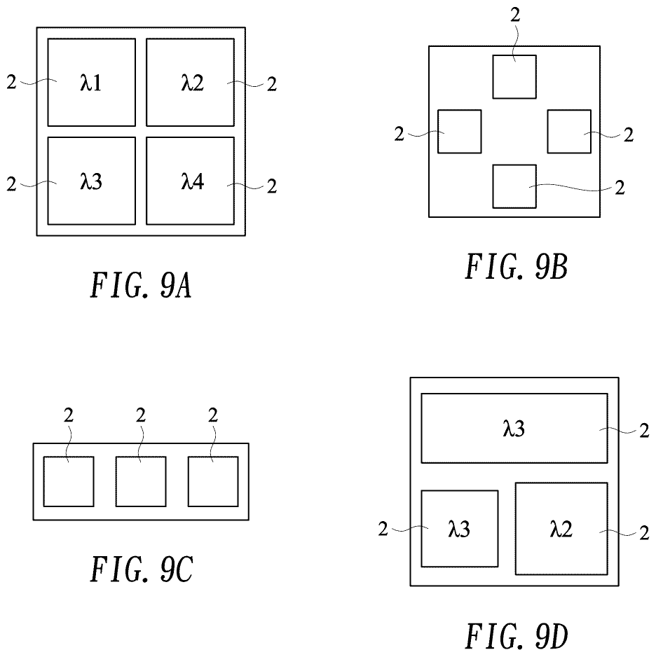

FIGS. 9A-9D show schematic simplified top views of various arrangement patterns of the patterned heating films in accordance with some embodiments of this invention. The patterned heating films 2 within a thermal infrared emitter chip could be arranged in various patterns, e.g., symmetrical grid (FIG. 9A), scattered (FIG. 9B), or row pattern (FIG. 9C), depending on the application and specific requirements. In addition, multiple patterned heating films 2 (heating regions) can be configured for various emission requirements based on client needs, and the optical radiation intensity can be modulated by varying the emission area of the patterned heating film 2 (heating region), as shown in the example of part (FIG. 9D).

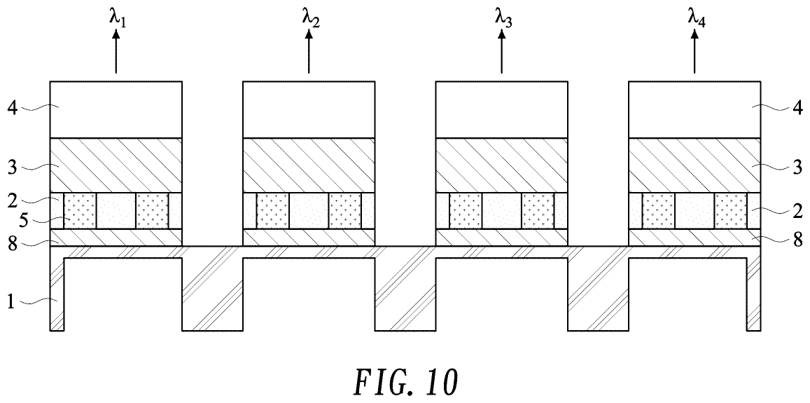

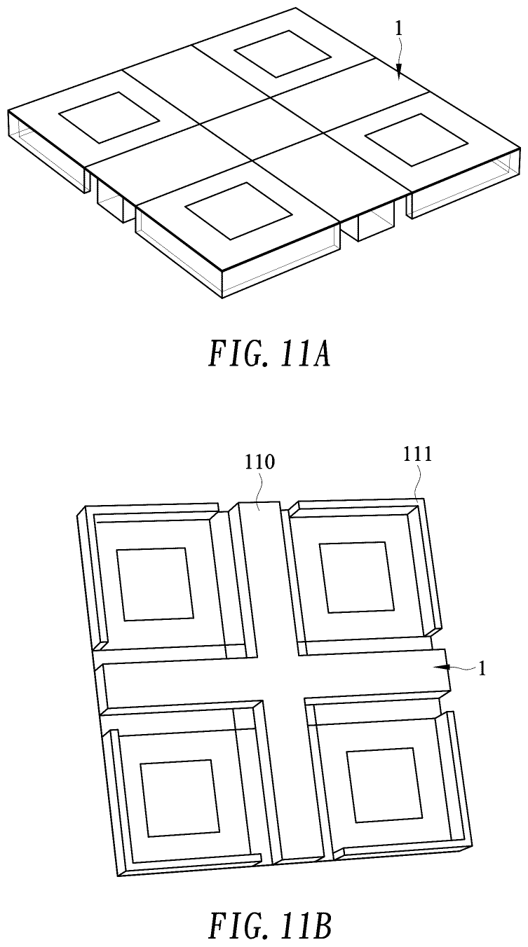

FIG. 10 is a side view showing a microelectromechanical (MEMS)-based thermal infrared emitter chip according to another embodiment of the present invention. The thermal infrared emitter chip described in FIG. 10 is similar to that described in FIGS. 7A-7C, except as described below. Referring to FIG. 10, in the illustrated embodiment each heating region further includes an isolation layer 8 interposed between the patterned heating film 2 and the substrate 1. Each patterned heating film 2 is equipped with one isolation layer 8 at the bottom to reduce thermal interference between them, enabling precise control of the emission functionality. To minimize heat dissipation, the isolation layer 8 offers effective thermal and electrical insulation. It can be composed of low thermal conductivity materials, such as SiO₂ or Si₃N₄, to reduce heat loss.

FIGS. 11A and 11B are front and bottom perspective views showing a substrate of a MEMS-based thermal infrared emitter chip according to an embodiment of the present invention. Referring to FIGS. 11A and 11B, to minimize heat conduction between the heating regions, a MEMS Process including, e.g., deposition, photolithography, etching, and/or micromachining is used to pattern the substrate 1. Heat transfer between heating regions may result in reduced heat conversion efficiency in the heating zone where the infrared radiation is to be emitted and generation of unwanted emitting wavelengths from other regions.

Referring to FIGS. 11A and 11B, in the illustrated embodiment, the chip is rectangular-shaped and the substrate 1 is hollowed below each heating region. In addition, a cross-shaped structure 110 is formed below the substrate 1 to separate the heating regions, and four L-shaped sidewalls 111 are formed below the substrate 1 to surround the four heating zones, respectively. The four L-shaped sidewalls 111 do not contact the cross-shaped structure 110, and the inflection points of the four L-shaped sidewalls 111 are located at the corners of the chip.

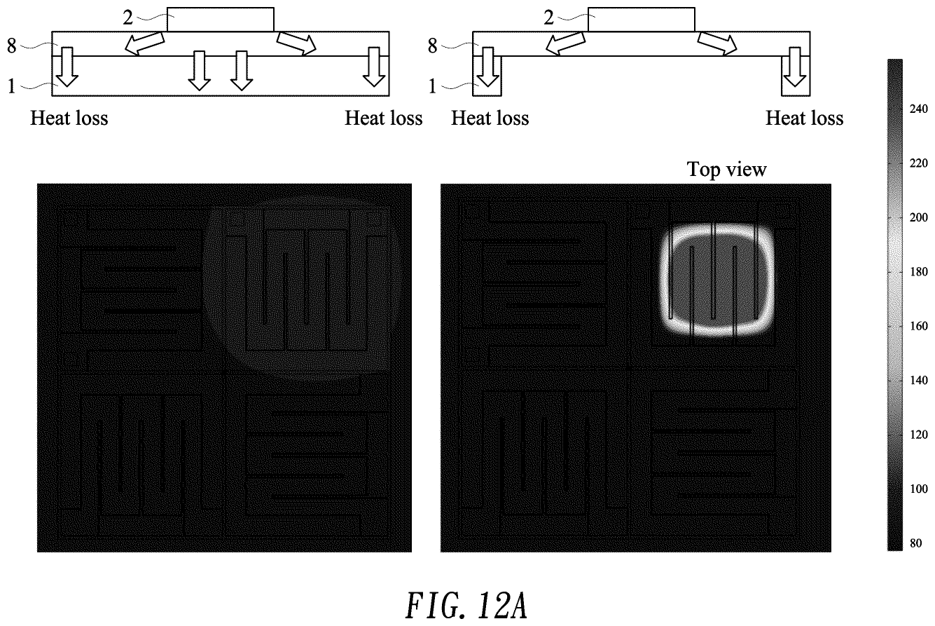

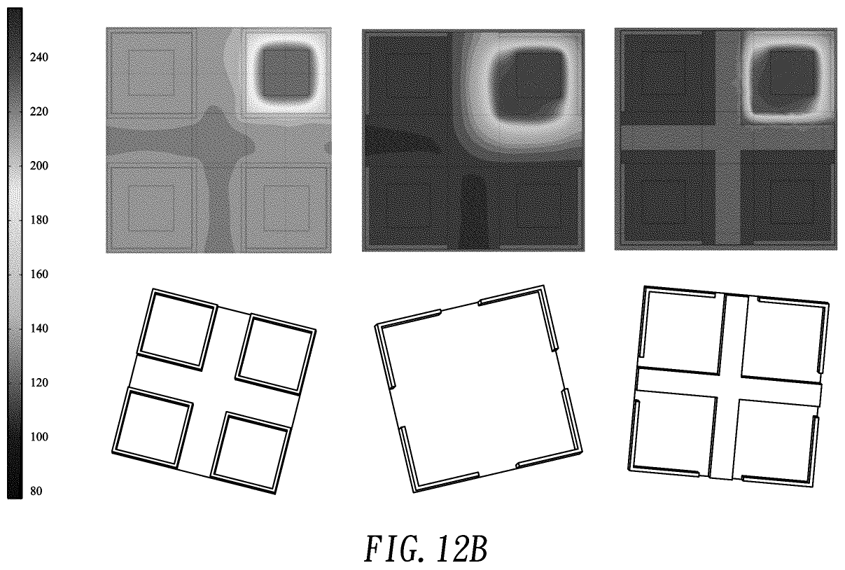

FIG. 12A is a thermal analysis simulation of two inventive chips wherein one of multiple heating regions is active and the bottom of substrate has or has no etched MEMS structure. The simulation results demonstrate that for the same pattern under the same input power, the chip with MEMS structure at the bottom shows a greatly improved thermal conversion efficiency compared with the one without a MEMS structure. By designing a back-etched geometric pattern, the heating region can be defined to increase the flexibility of partitioned, independent light emission.

FIG. 12B is a thermal analysis simulation of three inventive chips wherein one of multiple heating regions is active and the bottom of substrate has different etched MEMS structures. The simulation results demonstrate that the chip with the MEMS structure shown in FIGS. 11A and 11B has the best adiabatic effect between the active (ON) region and the inactive (OFF) regions.

The substrate 1 is preferably made of a material with a low thermal conductivity and insulating properties, thereby improving temperature conversion capability by limiting heat loss, reducing power consumption, and enabling faster thermal response. Based on the application and analysis, the substrate 1 may be, e.g., a sapphire substrate, a glass substrate, a silicon-on-insulator (SOI) substrate, or a polymer (such as polydimethylsiloxane, PDMS) substrate etc., and which could be rigid, flexible, transparent, or opaque. The substrate size is not limited; smaller substrates result in less heat dissipation, which helps enhance the component's response speed.

In one embodiment, the substrate 1 may be full-chip sized on which the miniature heaters are build via MEMS process. The thermal infrared emitter chip may be rectangular, square, circular or other shapes. In one embodiment, the thermal infrared emitter chip has a length dimension between 2.2 mm and 3.8 mm.

Although specific embodiments have been illustrated and described, it will be appreciated by those skilled in the art that various modifications may be made without departing from the scope of the present invention, which is intended to be limited solely by the appended claims.

What is claimed is:

1. A microelectromechanical (MEMS) based thermal infrared emitter chip, comprising:
a substrate comprising one or more heating regions, each of the heating regions comprising:
a patterned heating film disposed on the substrate to produce an infrared radiation by converting electrical energy into heat;
a resonant layer disposed on the patterned heating film; and
a metamaterial disposed on the resonant layer to pass through the infrared radiation within a narrow passband, wherein the metamaterial is composed of periodic subwavelength structures, and wherein the metamaterial, the resonant layer, and the patterned heating film constitute a metal-insulator-metal (MIM) structure, the infrared radiation irradiates the metamaterial to generate localized surface plasmon resonance (LSPR) that remains strongly confined in the resonant layer, and the metamaterial resonantly couples the infrared radiation, resulting in a resonant peak around a central wavelength of the narrow passband.

2. The thermal infrared emitter chip according to claim 1, further includes an optical homogenization layer to fill gaps of the patterned heated film, wherein the optical homogenization layer does not contact the patterned heated film.

3. The thermal infrared emitter chip according to claim 2, wherein the one or more heating regions comprises a plurality of heating regions, and the central wavelengths emitted from the plurality of heating regions are different from one another.

4. The thermal infrared emitter chip according to claim 2, wherein the one or more heating regions comprises a plurality of heating regions, and the central wavelengths emitted from the plurality of heating regions are the same.

5. The thermal infrared emitter chip according to claim 3, wherein the patterned heating films of the one or more heating regions are independently and selectively energized or de-energized.

6. The thermal infrared emitter chip according to claim 5, wherein the temperature of the de-energized heating regions is controlled below 100 °C.

7. The thermal infrared emitter chip according to claim 5, wherein the temperature of the de-energized heating region is controlled below 40 °C.

8. The thermal infrared emitter chip according to claim 3, wherein a shape and one or more geometric parameters of the periodic subwavelength structures of the metamaterial of the plurality of heating regions differ from one another.

9. The thermal infrared emitter chip according to claim 3, wherein the center wavelength is determined by a material of the resonant layer.

10. The thermal infrared emitter chip according to claim 3, wherein the center wavelength is determined by a thickness of the resonant layer.

11. The thermal infrared emitter chip according to claim 3, wherein a ration of a two-dimensional area of the MIM structure to an area of the thermal infrared emitter chip is greater than or equal to 80%.

12. The thermal infrared emitter chip according to claim 3, wherein the intensity at the center wavelength is positively linearly correlated to an area of the patterned heating film, and the positive linear relationship has a first slope.

13. The thermal infrared emitter chip according to claim 3, wherein the intensity at the center wavelength is positively linearly correlated to a temperature of the patterned heating film, and wherein the linear relationship has a second slope, and the second slope is greater than the first slope.

14. The thermal infrared emitter chip according to claim 3, wherein the central wavelengths emitted from the plurality of heating regions are between 2 μm and 25 μm.

15. The thermal infrared emitter chip according to claim 3, wherein each of the heating regions further comprises an isolation layer interposed between the patterned heating film and the substrate.

16. The thermal infrared emitter chip according to claim 1, wherein the metamaterial has a length direction and a width direction, and the metamaterial comprises a grating array composed of a plurality of grating patterns, and wherein a length of each of the plurality of grating patterns is parallel to the width direction.

17. The thermal infrared emitter chip according to claim 1, wherein the metamaterial has a length direction and a width direction, the metamaterial comprises a grating array composed of a plurality of grating patterns, and wherein a length of each of the plurality of grating patterns is parallel to the length direction, and the grating array is a two-dimensional array.

18. The thermal infrared emitter chip according to claim 1, wherein the one or more heating regions comprises a plurality of heating regions, and the central wavelengths emitted from the plurality of heating regions are different from one another.
